(19) United States
(12) Patent Application Publication
(10) Pub. No.: US 2015/0129490 A1
(43) Pub. Date: May 14, 2015

(54) Low Soluble Iron Diatomite Filter Aids

(71) Applicant: EP MINERALS, LLC, Reno, NV (US)

(72) Inventors: Qun Wang, Reno, NV (US); David Scott Keselica, Reno, NV (US); Kimberly Walsh, Reno, NV (US); Peter Edward Lenz, Reno, NV (US); Chongjun Jiang, Reno, NV (US); Bradley Scott Humphreys, Sparks, NV (US)

(73) Assignee: EP MINERALS, LLC, Reno, NV (US)

(21) Appl. No.: 14/076,581

(22) Filed: Nov. 11, 2013

(51) Int. Cl. C12H 1/07; B01J 20/14; B01J 20/02

(52) U.S. Cl. CPC C12H 1/063; B01J 20/0248; B01J 20/14
USPC 210/504; 423/625; 423/629; 432/9

(57) ABSTRACT

Processes for manufacturing low soluble iron diatomite filter aids and such filter aids are disclosed. Aluminum oxide and/or aluminum hydroxide are used as additives when preparing the flux-calcined diatomite filter aids. As compared to either straight-calcined or soda ash flux-calcined diatomite filter aids of similar permeabilities made from the same ore, the disclosed filter aids have lower soluble iron levels. For instance, disclosed filter aids of about 0.5 to about 2.0 Darcy were made using either an aluminum oxide or aluminum hydroxide additive with soda ash. The disclosed filter aids may have an EBC soluble iron content of less than 80 ppm versus 130 ppm for similar filter aids that were made from the same ore and flux-calcined with just soda ash.

### TECHNICAL FIELD

This disclosure relates to diatomite or diatomaceous earth filter aids with reduced soluble iron content and methods for reducing the soluble iron content of diatomite or diatomaceous earth filter aids.

### BACKGROUND

Diatomite (diatomaceous earth) is sediment that includes silica in the form of siliceous skeletons (frustules) of diatoms. Diatoms are a diverse array of microscopic, single-celled, golden-brown algae generally of the class Bacillariophyceae that possess ornate siliceous skeletons of varied and intricate structures. Because of these ornate skeletal structures, diatomite may be used as a filter aid for separating particles from fluids. The intricate and porous structures unique to diatomite can physically entrap particles during a filtration process. Diatomite can also improve the clarity of fluids that exhibit turbidity or contain suspended particles or particulate matter.

Because diatoms are water-borne, diatomite deposits are found at locations relating to either existing or former bodies of water. Further, diatomite deposits are generally divided into freshwater and saltwater categories.

When used as a filter aid, the iron in a diatomite product may become soluble in the liquid being filtered. In many applications, this increase in iron content in the fluid being filtered may be undesirable or even unacceptable. For example, when diatomite filter aids are used to filter beer, iron dissolved in the beer may adversely affect the taste and shelf-life of the beer. Thus, the brewing industry demands diatomite filter aids with a low content of iron that is soluble in beer.

The brewing industry has developed two protocols to measure the beer-soluble iron content of diatomite filter aids. In the European Brewing Convention (EBC) protocol, a 1% potassium hydrogen phthalate solution is contacted with the filter aid for two hours before the iron content of the solution is measured. In the American Society of Brewing Chemists (ASBC) protocol, a sample of beer is contacted with the filter aid for nine minutes and then the resulting iron content in the beer is measured.

Many methods have been developed to reduce the soluble iron content in diatomite filter aids. One such method is diatomite ore selection; some diatomite ores naturally contain less iron than other ores. Some other ores may contain relatively high iron content, but due to the overall ore chemistry, diatomite filter aids made from these ores may still have a relatively low soluble iron content. Ore selection alone, however, may not be sufficient to supply the brewing and other industries with required low soluble iron content diatomite filter aids.

Another method known to change soluble iron content in diatomite is the process of calcination. Calcination generally involves heating the diatomite at a high temperature, for example, in excess of 900° C. (1652° F.). There are two types of calcination processes that are commonly practiced in the diatomite industry: straight calcination and flux-calcination.

Straight calcination does not involve the addition of a fluxing agent, and usually reduces the presence of organics and volatiles in diatomite. Straight calcination may also induce a color change from off-white to tan or pink. Straight calcination is commonly used to produce filter aids of low to medium permeabilities, up to 0.7 Darcy. Unfortunately, straight calcination usually causes diatomite surface dehydration that is often accompanied by an increase of the soluble iron content of the calcined product. On the other hand, during calcination, the surface area of diatomite particles is reduced due to sintering and agglomeration. Surface area reduction of diatomite reduces the soluble iron content of diatomite because some of the iron in the diatomite becomes inaccessible to the particulate surfaces that come into contact with the liquid that is being filtered. Thus, surface dehydration caused by calcination increases the soluble iron content while surface area reduction caused by calcination reduces the soluble iron content. Still further, the calcination temperature and/or degree of calcination will also affect the soluble iron content.

For example, straight-calcined conventional diatomite filter aids made from certain ores near the higher end of their permeability range (0.3-0.7 Darcy) have a reduced soluble iron content, because the effects of the surface area reduction tend to dominate over the effects of surface dehydration. In contrast, with some diatomite ores, the effects of surface dehydration dominate the effects of surface area reduction causing the soluble iron content to increase with the degree of calcination until the diatomite becomes over-calcined. Over-calcined diatomite may have a severely reduced surface area and porosity and an increased wet bulk density, thereby rendering the product ineffective as a filter aid. As a result, straight-calcined diatomite filter aids of 0.3-0.7 Darcy made from some of these diatomite ores may have a high soluble iron content, sometimes over 100 ppm as determined by the EBC method.

Diatomite may also be flux-calcined with an alkali flux agent such as sodium carbonate (soda ash) or sodium chloride to make filter aids with permeabilities in the range of 0.5 to 10 Darcy. When diatomite is flux-calcined with sodium-based fluxing agents at moderate temperatures to produce filter aids with permeabilities in the range from 0.5 to 2 Darcy, the filter aids often have a higher soluble iron content than straight-calcined filter aids because the silica matrix is partially converted to a more soluble alkali silicate, thereby increasing the iron solubility. However, the calcination temperature is also relevant; a diatomite filter aid that is flux-calcined at higher temperatures and that has permeability of higher than 2 Darcy generally has a lower soluble iron content than a filter aid calcined at more moderate or lower temperatures due to the reduction in the effective surface area caused by the higher calcination temperature.

In summary, flux-calcined diatomite filter aids having permeabilities in the range of 0.5 to 2 Darcy are difficult grades to manufacture in terms of iron solubility control. To control the permeability or maintain the permeability within a low to moderate range, calcination may be carried out at a lower temperature. However, a lower calcination temperature may prevent a significant reduction of the surface area, leading to an increased soluble iron content. As a result, the net effect of using a sodium based flux agent generally is an increase in the soluble iron content.

The soluble iron content of a diatomite filter aid may naturally decrease with time after calcination. Surface re-hydration by humidity in ambient air, for example, is one natural mechanism of soluble iron reduction by the aging process. Achieving soluble iron content reduction naturally, however, may take months, and the results may fluctuate with the seasons and the selection of diatomite ore.

Hydration or water treatment at higher temperatures is known to accelerate the soluble iron reduction process. Typical hydration treatment may include spraying a diatomite filter aid with water and mixing the water with the filter aid while the filter aid is still hot, e.g., at temperatures ranging from about 60° C. (140° F.) to about 95° C. (203° F.). The treated filter aid may be held in containers, such as bins and rail cars, until the soluble iron content is reduced to the desired level. Hydration treatments may also include the use of steam and/or be done at a temperature higher than 100° C. (212° F.) in a pressurized vessel, as described in U.S. Pat. No. 7,767,621. However, hydration treatment may not be effective for certain diatomaceous filter aids that have relatively high soluble iron contents. Further, more intensified hydration treatments may not be cost effective. Hydration treatments are usually less effective for flux-calcined diatomite filter aids of medium permeabilities.

Chemicals may also be applied to filter aids to reduce the soluble iron content. Chemical processes include, for example, acid washing, as described in U.S. Pat. No. 5,656,568, as part of the process of making high purity diatomite filter aids. Leaching with chelating solutions such as ethylenediaminetetraacetic acid (EDTA) or citric acid is also practiced. Although such methods can be somewhat effective in reducing the soluble metal content, such processes are usually too expensive for conventional filter aid manufacturing. Another chemical treatment for soluble iron content reduction is described in U.S. Pat. No. 5,009,906, in which an alkali metal silicate solution is applied to a diatomite filter aid to reduce the content of soluble multivalent metals such as iron and aluminum. Yet another chemical treatment for soluble metal content reduction is described in U.S. Patent Application No. 2011/0174732 in which a metal blocking agent such as a phosphorous containing chemical such as an alkali (poly) phosphate is used to pretreat diatomite prior to calcination.

Therefore, a need exists for effective processes for producing diatomite filter aids with low soluble iron content, especially in the medium permeability range from about 0.5 to about 2 Darcy, and especially from ores that usually produce filter aid products with higher soluble iron levels.

### SUMMARY

In one aspect, a diatomite filter aid is disclosed that comprises at least one additive in the form of aluminum hydroxide (Al(OH)₃, also known as aluminum tri-hydroxide or alumina tri-hydrate or “ATH”) and/or aluminum oxide (Al₂O₃ or “alumina”). The disclosed filter aid also has a European Brewing Convention (EBC) soluble iron content of less than about 90 ppm and/or American Society of Brewing Chemists (ASBC) soluble iron content of less than about 70 ppm. The disclosed diatomite filter aid may have a permeability ranging from about 0.01 to about 10 Darcy.

In a refinement, the EBC soluble iron content may be less than about 80 ppm.

In a refinement, the ASBC soluble iron content may be less than about 60 ppm.

In any one or more of the embodiments described above, the filter aid may be produced by flux-calcination including using at least one fluxing agent and at least one ATH or alumina additive.

In any one or more of the embodiments described above, the filter aid may have a permeability ranging from about 0.5 to about 2 Darcy.

In any one or more of the embodiments described above, the fluxing agent may be an alkali metal salt.

In any one or more of the embodiments described above, the fluxing agent may be an alkali metal fluxing agent. In a refinement, the alkali metal fluxing agent may be soda ash.

In another aspect, a method for preparing a diatomite filter aid is disclosed that may include mixing at least one of ATH and/or alumina with diatomite to form a mixture. The method may further include calcining the mixture at a temperature ranging from about 900° C. to about 1200° C. to produce a filter aid product having an EBC soluble iron content of less than about 90 ppm and/or an ASBC soluble iron content of less than about 70 ppm. In another refinement, the EBC soluble iron content of the calcined diatomite filter aid product may be less than about 80 ppm. In yet another refinement, the ASBC soluble iron content of the calcined diatomite filter aid product may be less than about 60 ppm. In a refinement, the filter aid product may have a permeability ranging from about 0.01 to about 10 Darcy. In another refinement, the filter aid product may have a permeability ranging from about 0.5 to about 2 Darcy.

In a refinement of the above method, the mixing may further include mixing at least one fluxing agent with the at least one of aluminum oxide and aluminum hydroxide and the diatomite to form a mixture. In a refinement, the at least one fluxing agent may be present in the mixture in the amount of from about 0.1 wt % to about 10 wt %. In a refinement, the above method may include wet mixing the additives and the fluxing agent with diatomite and drying the mixture of diatomite, flux agent and additive before calcining the mixture. In another refinement, the method may include fine milling of the ATH and/or alumina prior to the mixing with the flux agent (if used) and the diatomite. In yet another refinement, the method may include co-milling of the at least one of the ATH and alumina with the alkali metal flux agent before the mixing.

If aluminum oxide is used as an additive, it may be in form of an amorphous powder or a fine powder of any crystalline phases of aluminum oxide, including but not limited to alpha aluminum oxide, gamma aluminum oxide, and any types described commercially, including but not limited to calcined, activated, reactive and micronized and submicron alumina. If ATH is used as an additive, it may be of an amorphous powder or a fine powder of any crystalline phases of aluminum hydroxide, occurring natural or synthetic and including but not limited to gibbsite, bayerite, doyleite and nordstrandite. The alumina and ATH additives may also include the related aluminum oxide-hydroxides such as boehmite.

If aluminum oxide is used as an additive, the aluminum oxide may have a median particle diameter of less than about 5 microns and a surface area exceeding about 5 m²/g. If an activated aluminum oxide is used as an additive, the activated aluminum oxide may have a median particle diameter of less than about 20 microns and a surface area exceeding about 100 m²/g. If ATH is used as the additive, the ATH may have a median particle diameter of less than about 5 microns and a surface area exceeding about 2 m²/g. Such fine alumina or ATH may be produced by milling or other processes.

In any one or more of the embodiments described above, the aluminum oxide or hydroxide may be present in the mixture in an amount ranging from about 1 wt % to about 10 wt %.

In any one or more of the embodiments described above, the ATH may be formed in situ by reacting an aluminum salt and a base with a hydroxyl group. The alumina additive may be formed by heating an aluminum hydroxide or ATH to remove water partially or completely.

In another embodiment, another method for preparing a diatomite filter aid is disclosed. The method may comprise providing boehmite and diatomite, mixing the boehmite with the diatomite to form a mixture, and calcining the mixture at a temperature ranging from 900° C. to about 1200° C. to produce the diatomite filter aid product having an EBC soluble iron content of less than about 90 ppm or an ASBC soluble iron content of less than about 70 ppm. In a refinement, the method may further comprise providing at least one fluxing agent, and the mixing may further include mixing the at least one fluxing agent with the boehmite and the diatomite to form the mixture.

In another embodiment a diatomite filter aid is disclosed. The filter aid may comprise boehmite, and a European Brewing Convention (EBC) soluble iron content of less than about 90 ppm or American Society of Brewing Chemist (ASBC) soluble iron content of less than about 70 ppm. The filter aid may have a permeability ranging from about 0.01 Darcy to about 10 Darcy. In a refinement, the diatomite filter aid may further include at least one fluxing agent. In an embodiment, the at least one fluxing agent may be an alkali metal salt, soda ash, sodium carbonate or the like.

In any one or more of the embodiments described above, the EBC soluble iron content may be less than about 90 ppm in some embodiments, less than about 80 ppm in other embodiments, and less than about 70 ppm in other embodiments. The ASBC soluble iron content may be less than about 70 ppm in some embodiments, less than about 60 ppm in other embodiments, and less than about 50 ppm, respectively in other embodiments.

In any one or more of the embodiments described above, the calcination feed mixture may further include water.

In any one or more of the embodiments described above, the flux agent may be an alkali metal salt, soda ash, sodium carbonate, or a combination thereof.

### DESCRIPTION

As a solution to the soluble iron problem associated with making filter aids from certain diatomite ores, aluminum oxide (Al₂O₃, “alumina”) and aluminum hydroxide (Al(OH)₃, “ATH”) are disclosed as effective additives for manufacturing diatomite filter aids with reduced soluble iron content, especially in the medium permeability range from about 0.5 to about 2 Darcy. The efficacies of alumina and ATH are established below.

The diatomite feedstock was prepared from a Nevada (US) fresh water diatomite ore by oven drying, hammer-milling and air classification. The particle size distributions (PSD) as measured by the laser diffraction method and chemistry properties of the diatomite feedstock as measured by X-ray fluorescence (XRF) are shown in Table I.

TABLE I
PSD and Major Element Chemistry of Diatomite Feed Stock - XRF (Ignited Basis)

| | PSD, μm | | | SiO₂ | Al₂O₃ | CaO | MgO | Na₂O | K₂O | Fe₂O₃ | TiO₂ | As | S |
|---|---|---|---|---|---|---|---|---|---|---|---|---|---|
| Diatomite | D₁₀ | D₅₀ | D₉₀ | % | % | % | % | % | % | % | % | ppm | ppm |
| Feedstock | 7.5 | 14.4 | 28.2 | 94.01 | 2.72 | 0.63 | 0.28 | 0.37 | 0.23 | 1.50 | 0.11 | 11 | 186 |

The various alumina and ATH samples used and their particle size and surface area properties are listed in Table II. The particle size distribution is measured by a Microtrac S3500 particle size analyzer after dispersion in the sodium silicate solution of pH 10.5.

TABLE II
Alumina and Aluminum Hydroxide Examples

| | | | Loss on | PSD | | | BET |
|---|---|---|---|---|---|---|---|
| | | Moisture | Ignition | (Microtrac, μm) | | | Surface |
| Type | Additive | % | % | D₁₀ | D₅₀ | D₉₀ | Area, m²/g |
| Aluminum | ATH-A | <1 | 35 | 1.3 | 3.5 | 7.8 | 25 |
| Hydroxide | ATH-B | 13 | 34 | 0.6 | 1.7 | 3.2 | 5.4 |
| | ATH-C | <1 | 34 | 0.8 | 2.0 | 4.1 | 4.2 |
| Alpha Alumina | Alumina-A | <1 | 1 | 0.6 | 0.8 | 5.1 | 24 |
| Submicron | Alumina-B | <1 | <1 | 0.4 | 0.7 | 1.7 | 7.3 |
| Alumina | | | | | | | |
| Reactive | Alumina-C | <1 | <1 | 0.5 | 0.8 | 15.1 | 7.4 |
| Alumina | | | | | | | |
| Activated | Alumina-D | <1 | 1 | 3.2 | 19.4 | 37.9 | 142 |
| Alumina | | | | | | | |

Calcination Feed Preparation

The flux agent used in the examples was soda ash, which was hammer-milled and passed through a 325-mesh screen. The soda ash and the alumina or ATH additive may be added to the diatomite feed as a dry powder by brushing the soda ash through a 100-mesh screen. The flux agent, diatomite feed and additive may be mixed in a conventional manner, such as by shaking in a plastic jar. The fluxing agent and alumina or ATH may also be added to a wet diatomite feed.

Batch Calcination

Batch calcination may be conducted in a conventional manner. In the examples shown here, the batch calcination was carried out in a clay crucible in an electrical muffle furnace, although a rotary tube furnace or other suitable furnace may be used. The calcination may also be carried out continuously and in an industrial calciner such as a rotary kiln. In the muffle furnace, the feed material was calcined in the clay crucible in air. The batch size was about 40 grams, and the clay crucible had a 7.6 cm (3 in.) diameter and an 11.4 cm (4.5 in.) height. The batches were calcined for about 40 minutes. The calcination products were dispersed by shaking through a 100-mesh screen. Other calcination methods are available, as will be apparent to those skilled in the art.

Muffle Furnace Calcination

Muffle furnace calcination results are listed in Tables IV, V and VI. Table IV shows the results using soda ash as a flux agent without an aluminum additive. Tables V and VI show the results using alumina and ATH as additives respectively.

TABLE III
Muffle Furnace Calcination at 1038° C. with 4% Soda Ash
and Alumina as Additive

| | | | | | Soluble contents, ppm | | |
|---|---|---|---|---|---|---|---|
| Exam- | | wt % as | Perm | WBD | EBC | EBC | ASBC |
| ple | Alumina | Al₂O₃ | Darcy | g/ml | Al | Fe | Fe |
| 1 | None | 0.0 | 1.1 | 0.29 | 32 | 130 | 96 |
| 2 | Alumina-A | 1.9 | 1.1 | 0.28 | 60 | 79 | 64 |
| 3 | Alumina-A | 4.0 | 0.9 | 0.31 | 72 | 64 | 49 |
| 4 | Alumina-B | 4.0 | 1.2 | 0.29 | 64 | 75 | 58 |
| 5 | Alumina-C | 4.0 | 1.1 | 0.29 | 75 | 67 | 45 |
| 6 | Alumina-D | 4.0 | 1.3 | 0.28 | 368 | 79 | 67 |

Applicants conducted tests with various aluminas (see Table II). As shown above in Table III, the iron solubility is reduced compared to the products calcined only with soda ash. Specifically, the EBC iron (Fe) values were reduced from about 130 ppm to a range of from about 60 to about 80 ppm. The ASBC Fe values dropped from about 95 ppm to a range from about 45 to about 70 ppm.

Alpha alumina additives with median particle sizes in excess of 5 μm median particle size and surface areas of less than 5 m²/g appear to be less effective as additives. As a result, an alpha-alumina that is an ultra-fine powder with a median particle size of less than 5 μm and with a surface area of greater than 5 m²/g is preferred. The higher specific surface area of an activated alumina, usually larger than 100 m²/g, appears to allow somewhat coarser or larger median particle size requirement.

TABLE IV
Muffle Furnace Calcination at 1038° C. with 4% Soda Ash and
Aluminum Hydroxide (ATH) as Additive

| | | | | | Soluble contents, ppm | | |
|---|---|---|---|---|---|---|---|
| | | wt. % as | Perm | WBD | EBC | EBC | ASBC |
| Example | ATH | Al(OH)₃ | Darcy | g/ml | Al | Fe | Fe |
| 1 | None | 0.0 | 1.1 | 0.29 | 32 | 130 | 96 |
| 7 | ATH-A | 6.0 | 1.2 | 0.29 | 132 | 65 | 42 |
| 8 | ATH-B | 5.2 | 1.1 | 0.29 | 90 | 60 | 37 |
| 9 | ATH-C | 6.0 | 1.2 | 0.30 | 79 | 73 | 64 |

At a calcination temperature of about 1038° C. (1900° F.) and with 4 wt % soda ash, adding an ATH (median particle size ranging from about 1.7 to about 3.5 μm (Table II)) reduced the EBC Fe level from about 130 to less than 80 ppm and the ASBC Fe solubility level from about 95 to less than 70 ppm (Table IV). Suitable ATHs for use as additives in flux-calcined low permeability filter aids should have a median particle size less than about 5 μm and/or a surface area exceeding about 3 m²/g. Although the median particle size requirement is the same as for alumina, the surface area requirement is less than the 5 m²/g lower limit for alumina. Without being bound to any particular theory, the reduced surface area that is required for efficacy of an ATH may be the result of additional surface area creation on the ATH particles during the calcination when the hydroxide dehydrates and converts to a highly porous oxide. Water evolution during calcination may also help the reactions.

The use of the aluminum additive tends to increase the soluble aluminum content of the products of this invention. The content of the soluble aluminum in most cases is still within an acceptable range, say, <200 ppm as measured by the EBC method. And the soluble aluminum content of the diatomite filter aid products of this invention can be controlled or managed by additive selection and optimizing the process conditions such as reducing the usage of soda ash and/or the aluminum additive and increasing calcination temperature.

### INDUSTRIAL APPLICABILITY

New processes have been developed to make diatomaceous earth filter aids with reduced soluble iron content, especially those having permeabilities in the 0.01-10 Darcy range. In this development, an alumina or ATH additive is used. As compared to either straight-calcined or flux-calcined products of similar permeabilities, the new products have much lower iron solubility. For example, diatomite filter aids of 0.5-2 Darcy permeabilities are disclosed that are made with alumina or ATH and soda ash. The disclosed filter aids have an EBC soluble iron content of less than about 90 ppm and an ASBC soluble iron content of less than about 70 ppm versus comparable soda ash flux-calcined filter aids of similar permeabilities but with soluble EBC and ASBC iron contents of about 130 ppm and 95 ppm respectively. In conclusion, disclosed methods can be used to make diatomaceous earth filter aids having low iron solubilities, especially in the range of from about 0.5 Darcy to about 2.0 Darcy.

What is claimed is:

1. A diatomite filter aid comprising:
at least one of aluminum oxide and aluminum hydroxide; and
a European Brewing Convention (EBC) soluble iron content of less than about 90 ppm or American Society of Brewing Chemist (ASBC) soluble iron content of less than about 70 ppm;
wherein the filter aid has a permeability ranging from about 0.01 Darcy to about 10 Darcy.

2. The diatomite filter aid of claim 1, wherein the EBC soluble iron content is less than about 80 ppm.

3. The diatomite filter aid of claim 1, wherein the ASBC soluble iron content is less than about 60 ppm.

4. The diatomite filter aid of claim 1, wherein the filter aid has a permeability ranging from about 0.5 Darcy to about 2 Darcy.

5. The diatomite filter aid of claim 1, further comprising a fluxing agent, wherein the fluxing agent is an alkali metal salt.

6. The diatomite filter aid of claim 1, further comprising an alkali metal fluxing agent, wherein the alkali metal fluxing agent is soda ash.

7. A method for preparing a diatomite filter aid product comprising:
providing at least one of aluminum oxide and aluminum hydroxide, and providing diatomite;
mixing the at least one of aluminum oxide and aluminum hydroxide with the diatomite to form a mixture; and
calcining the mixture at a temperature ranging from 900° C. to about 1200° C. to produce the diatomite filter aid product having an EBC soluble iron content of less than about 90 ppm or an ASBC soluble iron content of less than about 70 ppm.

8. The method of claim 7, wherein the at least one of aluminum oxide and aluminum hydroxide is amorphous aluminum hydroxide.

9. The method of claim 7, wherein the at least one of aluminum oxide and aluminum hydroxide is amorphous aluminum oxide.

10. The method of claim 7, wherein the EBC soluble iron content of the diatomite filter aid product is less than about 80 ppm.

11. The method of claim 7, wherein the ASBC soluble iron content of the diatomite filter aid product is less than about 60 ppm.

12. The method of claim 7, wherein the diatomite filter aid product has a permeability ranging from about 0.01 Darcy to about 10 Darcy.

13. The method of claim 7, wherein the diatomite filter aid product has a permeability ranging from about 0.5 Darcy to about 2 Darcy.

14. The method of claim 7, wherein the aluminum oxide or aluminum hydroxide is present in the mixture in an amount ranging from about 1 wt % to about 10 wt %.

15. The method of claim 7, wherein the providing of the at least one of aluminum oxide and aluminum hydroxide includes providing an aluminum salt and a base that includes a hydroxyl group and reacting the aluminum salt and the base to provide aluminum hydroxide.

16. The method of claim 7, wherein the providing further includes:
fine milling of the at least one of aluminum hydroxide and aluminum oxide.

17. The method of claim 7, wherein the at least one of aluminum oxide and aluminum hydroxide is aluminum hydroxide that has a median particle diameter of less than about 5 microns and a surface area of greater than about 2 m²/g.

18. The method of claim 7, wherein the at least one of aluminum oxide and aluminum hydroxide is aluminum oxide that has a median particle diameter of less than about 5 microns and a surface area of greater than about 5 m²/g.

19. The method of claim 7, wherein the at least one of aluminum oxide and aluminum hydroxide is activated aluminum oxide that has a median particle diameter of less than about 20 microns and a surface area of greater than about 100 m²/g.

20. The method of claim 7, further comprising providing at least one fluxing agent, and
the mixing further includes mixing the at least one fluxing agent with the at least one of aluminum oxide and aluminum hydroxide, and the diatomite to form the mixture.

21. The method of claim 20, wherein the at least one fluxing agent is an alkali metal salt.

22. The method of claim 20, wherein the at least one fluxing agent is soda ash or sodium carbonate.

23. The method of claim 20, wherein the at least one fluxing agent is present in the mixture in an amount ranging from about 0.1 wt % to about 10 wt %.

24. The method of claim 7, wherein the at least one of aluminum oxide and aluminum hydroxide is a polymorph of aluminum hydroxide selected from the group consisting of gibbsite, bayerite, doyleite and nordstrandite.

25. The method of claim 7, wherein the at least one of aluminum oxide and aluminum hydroxide is alpha aluminum oxide or gamma aluminum oxide.

26. The method of claim 7, wherein the at least one of aluminum oxide and aluminum hydroxide is aluminum oxide selected from the group consisting of calcined alumina, reactive alumina, micronized alumina and submicron alumina.

27. A method for preparing a diatomite filter aid product comprising:
providing boehmite, and providing diatomite;
mixing the boehmite with the diatomite to form a mixture; and
calcining the mixture at a temperature ranging from 900° C. to about 1200° C. to produce the diatomite filter aid product having an EBC soluble iron content of less than about 90 ppm or an ASBC soluble iron content of less than about 70 ppm.

28. The method of claim 27, further comprising providing at least one fluxing agent, and
the mixing further includes mixing the at least one fluxing agent with the boehmite and the diatomite to form the mixture.

29. A diatomite filter aid comprising:
boehmite; and
a European Brewing Convention (EBC) soluble iron content of less than about 90 ppm or American Society of Brewing Chemist (ASBC) soluble iron content of less than about 70 ppm;
wherein the filter aid has a permeability ranging from about 0.01 Darcy to about 10 Darcy.

30. The diatomite filter aid of claim 29, further comprising at least one fluxing agent.
